(19) United States
(12) Patent Application Publication
(10) Pub. No.: US 2003/0065823 A1
(43) Pub. Date: Apr. 3, 2003

(54) Digital data adapter (DDA) for connecting a digital satellite receiver and a personal computer

(76) Inventor: Paul Kim, Germantown, MD (US)

Correspondence Address: Stacey J. Longanecker, Roylance, Abrams, Berdo & Goodman, L.L.P., Suite 600, 1300 19th Street, N.W., Washington, DC, 20036, US

(21) Appl. No.: 09/984,973

(22) Filed: Oct. 31, 2001

Related U.S. Application Data
(60) Provisional application No. 60/318,633, filed on Sep. 13, 2001.

(51) Int. Cl. G06F 15/16

(52) U.S. Cl. 709/250

(57) ABSTRACT

A terminal is provided for connecting a receiver which receives broadcast content transmitted from a satellite with a computer which can process at least part of the content. The terminal is operable to convert the broadcast programs received from the receiver from a first signal format to a second signal format, wherein the second formatted signal is provided to the computer. Exemplary first and second signal formats are a Broadcast Channel Input Output (BCIO) format and a Universal Serial Bus (USB) format respectively.

### CROSS-REFERENCE TO RELATED APPLICATIONS AND PATENT PUBLICATIONS

Related subject matter is disclosed in the co-pending U.S. provisional patent application serial No. 60/318,633, filed Sep. 30, 2001, which is hereby incorporated by reference in its entirety.

The following issued U.S. patents and published international applications disclose subject matter related to that of the present application and are also incorporated by reference herein in their entirety:

| | |
|---|---|
| 5,835,487 | 6,115,366 |
| 5,864,546 | 6,185,265 |
| 5,867,490 | 6,201,798 |
| 5,870,390 | 6,249,514 |
| 5,898,680 | WO 99/49602 |
| 5,966,442 | WO 99/13644 |
| 6,105,060 | WO 00/20957 |
| 6,108,319 | |

### FIELD OF THE INVENTION

The present invention relates generally to the reception of broadcast information and is particularly concerned with a method and system for processing real-time video and data broadcast transmissions for a computer via a portable digital data adapter (DDA).

### BACKGROUND OF THE INVENTION

Due to the expanding, worldwide use of personal computing devices and the Internet, the global economy is currently undergoing an information revolution that is expected to be as significant as the industrial revolution of the nineteenth century. A significantly large population of people, however, are generally under-served and dissatisfied with their telecommunications options and are, therefore, presently limited in their ability to participate in this information revolution. This population of people are primarily located in Africa, Central America, South America and Asia, where communication services have, to date, been characterized by the poor sound quality of short-wave radio broadcasts, or the coverage limitations of amplitude modulation (AM) band and frequency modulation (FM) band terrestrial radio broadcast systems.

A satellite-based direct radio broadcast system to transmit audio and data signals, including images, to receivers in essentially any part of the world has been proposed. The satellite based direct radio broadcast system provides a number of advantages over existing satellite data transmission systems, such as the ability to provide portable services. Many existing satellite systems fail to provide portable services because they require large satellite antennas for reception on such systems.

Low orbit (LEO) satellite systems are currently used to serve mobile and portable users. In addition, a number of geostationary satellite systems can provide portable or mobile communication services. However, existing LEO and geostationary satellite systems do not provide adequate channel capacity to provide the high outbound data rates required for transmission of information from the Internet and the World Wide Web (WWW) to many different users.

Systems have been proposed to use satellites to provide worldwide Internet/WWW access capability to fixed receivers. For example, systems which use geostationary satellites and multiple spot beams have been proposed, as well as systems comprising hundreds of satellites in a geodesic dome-like arrangement around the Earth or in multiple orbits. These systems, however, fail to provide global portable Internet/WWW access capability.

A personal computer (PC) dual channel card has been proposed by the applicant in the above-referenced in co-pending application 60/318,633, filed Sep. 30, 2001. The PC card allows a user to configure a PC to receive and process satellite broadcast transmission by installing the card in one of the available card slots in the PC chassis. A need exists, however, for an apparatus that allows for low cost configuration of a PC for satellite broadcast transmission in conjunction with a satellite receiver which does not require substantial modification of the PC hardware or software. Preferably, the apparatus provides one way communication to minimize costs and also provide at least two levels of security to prevent unauthorized users from accessing information on the broadcast channels.

### SUMMARY OF THE INVENTION

In view of the foregoing, it is an object of the present invention to process video and data information transmitted via a satellite broadcast using digital data adapter (DDA) terminal that is relatively low-cost and simple to install and use. The invention makes use of a satellite radio to receive audio, video, data and other information, to process audio information and to convey video and data information to a personal computer. The DDA terminal serves as an interface between a satellite radio device and a personal computer and processes broadcast channel information.

It is a further object of the present invention to provide at least two levels of security for decoding the satellite broadcast channels. The first level of security requires a user to enter a password via the satellite radio device.

The second level of security requires the DDA to detect its internal identification number within the satellite broadcast channel before decoding of the video and data signal.

It is a further object of the invention to provide a device that is powered from the computer and does not require battery operation or direct connection to a household power outlet to operate.

### BRIEF DESCRIPTION OF THE DRAWINGS

The various objects, advantages and novel features of the present invention will be more readily understood from the following detailed description when read in conjunction with the appended drawings, in which:

FIG. 1 is a block diagram illustrating the manner in which global, portable Internet access can be provided to users through a satellite direct radio broadcast system in accordance with an embodiment of the present invention;

FIG. 2 depicts a block diagram illustrating the manner in which a digital data adapter (DDA) terminal operates in a satellite broadcast system of the type shown in FIG. 1 in accordance with an embodiment of the present invention;

FIG. 3 is a block diagram depicting a driver software architecture for the DDA card of FIG. 2 in accordance with an embodiment of the present invention; and

FIG. 4 is a block diagram depicting the operation of the data stream handler of FIG. 3 in accordance with an embodiment of the present invention.

Throughout the drawing figures, like reference numerals will be understood to refer to like parts and components.

### DETAILED DESCRIPTION OF THE INVENTION

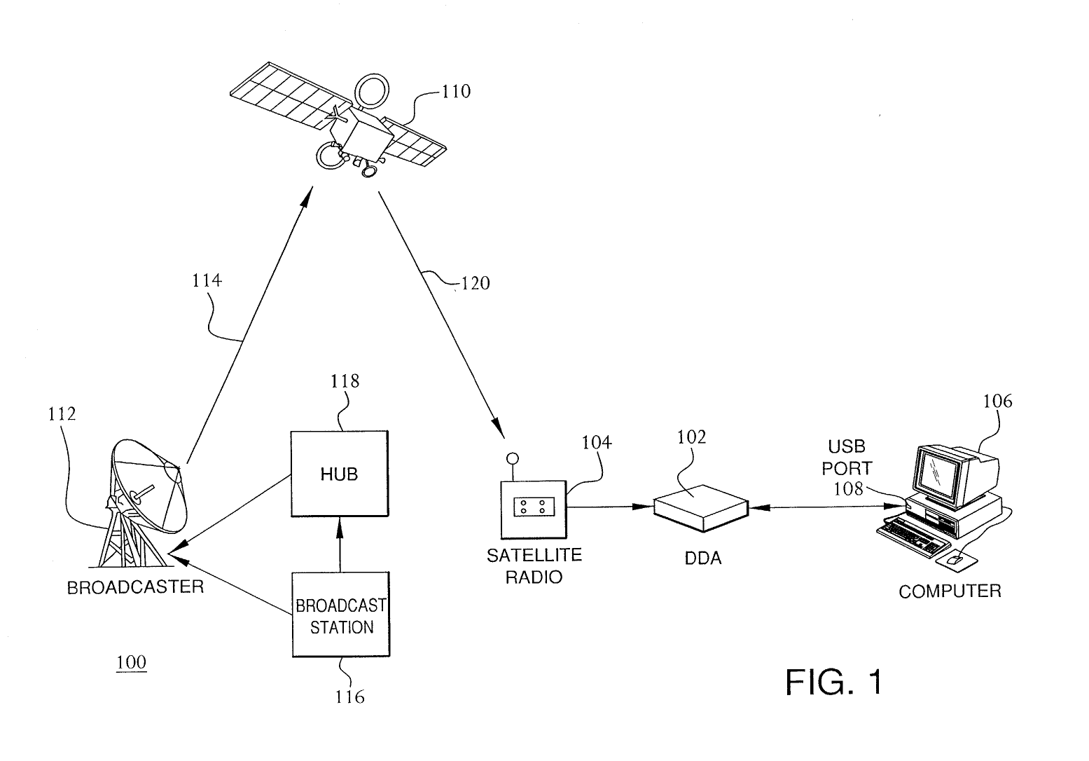

A global, portable Internet service system 100 for providing a remotely located user with the ability to receive high quality sound, data and video, and to process the information, in accordance with the present invention is preferably implemented using a satellite direct radio broadcast system as shown in FIG. 1. The direct broadcast system preferably consists of one or more geostationary satellites (one of which is indicated at 110 in FIG. 1), a digital data adapter terminal 102 connected to a satellite radio 104 and to a computer 106 via a universal serial bus (USB) port 108, and associated ground networks.

The preferred satellites 110 of the direct radio broadcast system cover the African-Arabian region, the Asian region and the Caribbean and Latin American regions from the following geostationary orbits:

21 degrees E orbital location, providing service to Africa and the Middle East.

95 degrees W orbital location, providing service to Central and South America.

105 degrees W orbital location, providing service to Southeast Asia and the Pacific rim.

Coverage for other areas, such as North America and Europe, can be provided with additional satellites.

The direct radio broadcast system preferably uses the frequency band of 1467 to 1492 MHz, which has been allocated for Broadcasting Satellite Service (BSS) Direct Audio Broadcast (DAB) at WARC 92, that is, in accordance with resolutions 33 and 528 of the ITU. The broadcasters 112 use feeder uplinks in X band, from 7050 to 7075 MHz.

The direct radio broadcast system uses digital audio coding techniques. Each satellite 110 delivers digital radio audio signals having qualities equivalent to AM monaural, FM monaural, FM stereo and CD stereo throughout its respective coverage area, together with ancillary data such as paging, video and text transmissions directly to the satellite radio 104. The system may also deliver multimedia services such as large database downloads to PCs for business applications, map and printed text information for travelers, and even color to augment audio programs for advertising and entertainment.

System broadcasters organize their services in terms of program channels, each consisting of one or more 16 kilobit per second (kbps) prime rate channels. The number of prime rate channels per program channel can range from 1 to 8, thus yielding a program channel bit rate of 16 to 128 kbps in 16 kbps increments. Each broadcaster selects the number of 16 kbps prime rate channels in accordance with the broadcaster's specific application. For each 16 kbps increment, there is also a service control header that carries 519 bps, bringing the total bit rate per prime channel to 16.519 kbps.

To protect the broadcaster's program channel, a forward error correction (FEC) method is used. It comprises a Reed Solomon (255,223) coder concatenated with an interleaver, and a rate ½ Viterbi constant length coder. This error correction coding (together with the addition of a sync header) elevates the prime rate channel to 19 kbps.

Each satellite is preferably equipped with three downlink spot beams, having beamwidths of about 6 degrees. Each beam covers approximately 14 million square kilometers within power distribution contours that are about 4 dB down from the center and 28 million square kilometers within contours that are 8 dB down. The beam center margin may be 14 dB based on a receiver gain-to-temperature ratio of −13dB/K.

Each satellite 110 preferably carries two types of payloads. One is a processing payload that regenerates the uplink signals and assembles three TDM downlink carriers, and the other is a transparent payload that repeats the uplink signals on three TDM downlink carriers. The TDM signals from the two payloads are each transmitted in three beams, with the processed and transparent signals in each beam having opposite circular polarization (LHCP and RHCP). Each TDM downlink signal carries 96 prime rate channels in assigned time slots. To a radio receiver, all of the TDM downlink signals appear the same, except for carrier frequency. The total capacity per satellite is 2×3×96=576 prime rate channels.

The TDM downlink carriers will now be described in further detail. Their format is preferably the same, regardless of whether the TDM downlink carriers are generated by the processing payload, or at a broadcast station 116 for satellite transmission via the transparent payload. As stated above, digital information assembled by a broadcast service provider 112 at a broadcast station 116 is preferably formatted in 16 kbps increments or PRIs where n is the number of PRIs purchased by the service provider (i.e., n×16 kbps). The digital information is then formatted into a broadcast channel frame having a service control header (SCH). Each frame is preferably scrambled by addition of a pseudorandom bit stream to the SCH. Information control of the scrambling pattern by a key permits encryption. The bits in a frame are subsequently coded for forward error correction (FEC) protection using preferably two concatenated coding methods such as the Reed Solomon method, followed by interleaving, and then convolution coding (e.g., trellis convolution coding described by Viterbi). The coded bits in each frame corresponding to each PRI are subsequently subdivided or demultiplexed into n parallel prime rate channels (PRCs). To implement recovery of each PRC, a PRC synchronization header is provided.

If the processing payload is used, each of the n PRCs is next differentially encoded and then modulated using, for example, quadrature phase shift keying modulation onto an intermediate frequency (IF) carrier frequency. The n PRC IF carrier frequencies constituting the broadcast channel of a broadcast station 116 is converted to the X-band for transmission to the satellite 110. The carriers from the broadcast stations 116 are single channel per carrier/frequency division multiple access (SCPC/FDMA) carriers. On-board each satellite 110, the SCPC/FDMA carriers are received, demultiplexed and demodulated to recover the PRC carriers.

The PRC digital baseband channels recovered by the processing payload, or being processed at a broadcast station 116 for transparent payload transmission, are provided to TDM frame assemblers. The PRC digital streams are routed to the TDMA frame assemblers in accordance with a switching sequence unit that is controlled from an earth station. The symbols of the PRCs are preferably not grouped contiguously in a TDM frame, but rather are spread over the frame. By way of an example, there are preferably 2622 sets of symbols contained in the PRC portion of a TDM frame. In each set, there is one symbol for each PRC in a position which is numbered in ascending order from 1 to 96. Thus, all symbols belonging to PRC 1 are in the first position of all 2622 sets. Symbols belonging to PRC 2 are in the second position of all 2622 sets, and so on. This arrangement for numbering and locating the symbols of the PRCs in the TDM frame minimizes the size of the memory for performing the switching and routing on-board the satellite and for demultiplexing in the receiver. A time slot control channel (TSCC) is provided to the TDM frame to identify time slot locations of PRC symbols. The TSCC is recovered from a TDM demultiplexer and provided to the controller at the radio receiver to recover the n PRCs for a particular broadcast channel.

In other words, radio receivers 104 are configured to receive any of the three TDM carriers and to demodulate the received carrier. The radio receivers 104 are designed to synchronize a TDM bit stream using a master frame preamble provided during on-board satellite processing, if the payload processing was used. PRCs are demultiplexed from the TDM frame using the TSCC. The digital streams are then remultiplexed into the FEC-coded PRC format. The FEC processing preferably includes decoding using a Viterbi trellis decoder, for example, deinterleaving, and then Reed Solomon decoding to recover the original broadcast channel comprising n×16 kbps channel and the SCH. The n×16 kbps segment of the broadcast channel can be supplied to an MPEG 2.5 Layer 3 source decoder for conversion back to audio. The radio received can then accept a broadcast selection identified by the radio operator, combines this selection with the PRC information contained in the TSCC, and extracts and reorders the symbols of the PRCs from the TDM frame to restore the n PRCs for the selected broadcast content.

FIG. 1 illustrates the overall operation of a DDA terminal 102 in conjunction with a computer 106 and satellite radio 104 in accordance with a preferred embodiment of the present invention. In the case of the satellite processing payload, uplink signals 114 are transmitted by broadcasters 112 located anywhere within terrestrial visibility of the satellite 110 with elevation angles higher than 10 degrees via individual frequency division multiple access (FDMA) channels from broadcast stations 116. Each broadcaster 112 has the ability to uplink directly from its own facilities to one of the satellites 110 placing one or more 16 kbps prime rate channels on the FDMA carriers. Alternatively, broadcasters 112 which have no capacity for direct access to the satellite 110 can have access to a hub station 118. The hub station 118 serves to aggregate content from multiple broadcasters to meet the uplink bandwidth requirement for a broadcast channel. Use of FDMA for the uplink offers the highest possible flexibility between multiple independent broadcast stations.

Conversion between uplink FDMA and downlink multiple-channel-per-carrier, time division multiplex (MCPC/TDM) in the direct radio broadcast system of FIG. 1 is achieved on board the satellite 110 by an on-board processor. At the satellite 110, each prime rate channel transmitted by the a broadcast station 116 is demultiplexed and demodulated into individual 16 kbps baseband signals. Individual channels are routed via a switch to one or more of the downlink beams 120, each of which is a single TDM signal. This baseband processing provides a high level of channel control in terms of uplink frequency allocation and channel routing between uplink and down link. Uplink signals are received in the satellite in X band and converted to L band by the on-board processor. The downlinks 120 to the DDA terminal 102 use MCPC/TDM carriers. One such carrier is used in each of the three beams on each satellite 110.

For the transparent payload, the TDM signals are assembled at a broadcast station and appear in the same structure as the TDM signals assembled on board the satellite 110 by the processing payload. The TDM signal is sent to the satellite in the X band and is repeated in the L band in one of the three downlink beams. The power level is the same for the downlink TDM signals generated by the processing payload.

As will be described hereinafter, signals from the satellite 110 are received by the satellite radio 104 and provided to the DDA terminal 102. A user enters a password via the satellite radio 104 to access the broadcast channel content. The satellite radio 104 is used to select the broadcast channels. Specifically, the satellite radio serves as a tuner and processes the audio content on the broadcast channel for playback. The data and video content is provided to the DDA terminal 102 which is connected to both the satellite radio 104 and to the computer 106.

The DDA terminal 102 processes the data and video content of the broadcast channel. However, before providing the video and/or data content to the computer 106, the DDA terminal 102 monitors the broadcast channel for authorization information. Specifically, the DDA terminal 102 prevents the decrypted satellite signals from being forwarded to the computer 106 unless the DDA terminal 102 detects its serial number in the satellite bitstream. Upon detecting its serial number, the DDA terminal 102 provides the decoded data and/or video content to the computer 106 via the USB port 108. The DDA terminal 102 can be preferably powered by the computer 106 via the USB port 108. Thus, the DDA terminal 102 is portable and is not limited by the weight constraints of batteries and/or proximal location with respect to an A/C power source.

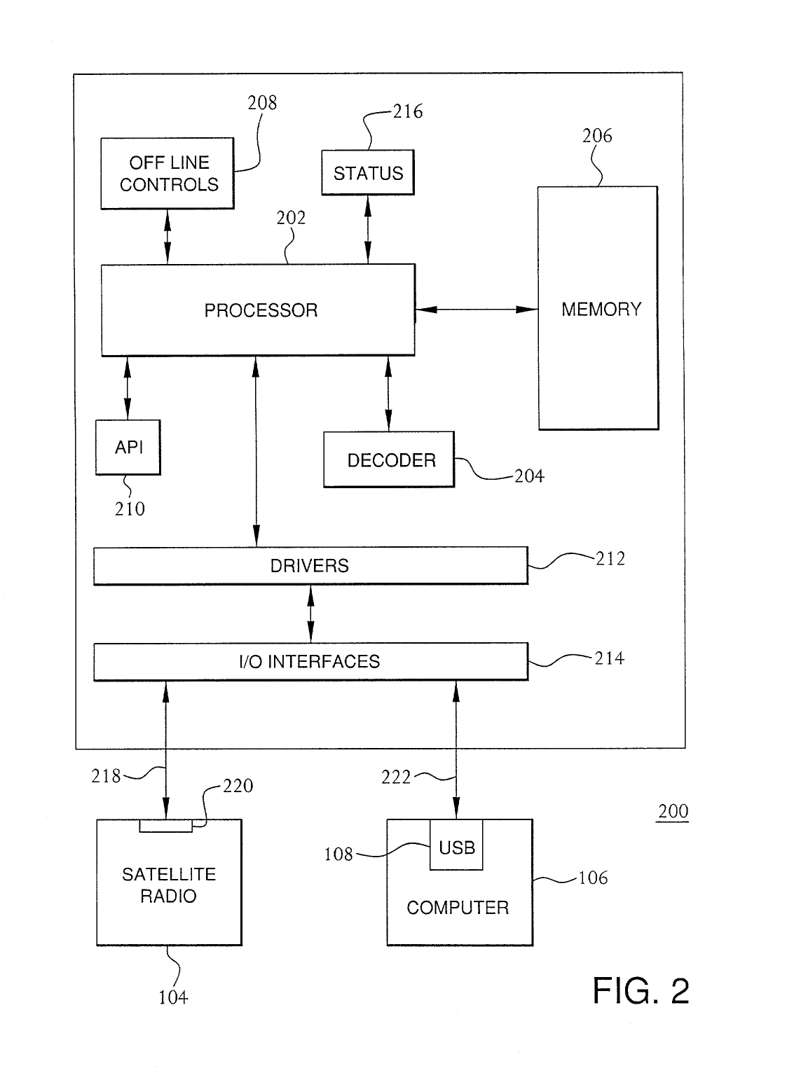

FIG. 2 depicts a block diagram 200 illustrating the manner in which the DDA terminal 102 operates in a satellite broadcast system of the type shown in FIG. 1. The DDA terminal 202 is connected to the satellite radio 104 and the computer 106 via the USB port 108. Specifically, the DDA terminal 102 comprises a processor 202 which is connected to a decoder 204, a memory device 206, offline controls circuit 208, an application programming interface (API) 210, drivers 212, input/output (I/O) interfaces 214 and status indicators 216.

The broadcast channels are received at the satellite radio 104. A user selects the desired satellite broadcast channel. If the satellite broadcast channel contains only audio, the content is processed and output by the satellite radio. If the satellite broadcast channel contains video and/or data, the content is provided to the DDA terminal 102. The connection between the DDA terminal 102 and the satellite radio 104 can preferably be a broadcast channel input/output (BCIO) interface port. The DDA terminal 102 uses a connector cord 218 preferably uses a Hosiden or Hosiden-compatible connector cord having a Hosiden or Hosiden-compatible connector member 220 with pins to connect to the satellite radio 104. The connector cord 218 is preferably fixedly attached to the DDA terminal 102 via a at least one meter cord. The connector member 220 connects to the Satellite radio's 104 BCIO interface port.

It will be appreciated by those skilled in the art that although the Hosiden or Hosiden-compatible cord is described as being at least one meter, the length of the cord can vary in size, and be retractable or non-retractable.

TABLE 1
illustrates exemplary pin settings for the
Hosiden connector member 220.

| | | | Signal Direction |
|---|---|---|---|
| | | | (relative to |
| Pin # | Signal Name | Description | DDA) |
| 9 | BCDₒᵤₜ | Broadcast | Input |
| | | Channel Data | |
| | | Output | |
| 8 | BCC | Broadcast | Input |
| | | Channel Clock | |
| 2 | GND | Ground voltage | Input |
| | | reference | |
| 5 | VCC | Radio power | Input |
| | | supply | |
| | | reference | |

The BCDₒᵤₜ signal contains content from the satellite broadcast channel. The DDA terminal receives the BCDₒᵤₜ signal on pin 9. Timing for the DDA terminal 102 is derived from pin 8 via the BCC signal. The GND signal is received by the DDA terminal 102 on pin 2 and provides a common voltage reference between the DDA terminal 102 and the satellite radio 104. The DDA terminal 102 can optionally use the VCC signal as a status input signal to determine whether the satellite radio 104 is on. However, less than 1 mA is drawn from the satellite radio 104 via pin 5.

The video or data content is extracted from the BCDₒᵤₜ pin by the DDA terminal 102. Specifically, the content is received at I/O interfaces 214 and formatted. The formatted signal is then provided to drivers 212 where frame and byte synchronization is performed on the broadcast channel content. The drivers 212 include hardware, as well as software drivers, necessary to perform the functions of frame and byte synchronization. It will be appreciated by those skilled in the art that drivers similar to those found in DDA terminal 102 can also reside in computer 106. Thus, the drivers in computer 106 can operate in like manner to those found in DDA terminal 102.

The synchronized broadcast channel content is provided to the processor 202. Processor 202 is preferably an 8 or 16 bit micro-controller unit and controls and monitors the various components and processes of the DDA terminal 102. For example, processor 202 monitors the header information in the broadcast channel content for the serial number of the DDA terminal 102. The serial number can be contained in memory device 206, along with programs necessary to operate the DDA terminal 102, or can be stored in the processor 202.

If the serial number is not detected in the satellite broadcast channel, the content is not decoded by decoder 204. However, if the DDA terminal's 102 serial number is detected, the decoder 204 decodes the satellite broadcast channel content and provides the decoded content to the PC via the API 210, drivers 212, I/O interfaces 214, USB connector cable 222 and USB port 108.

The API 210 frame synchronizes the broadcast channel and provides the broadcast stream content to the next application level using user datagram protocol (UDP) through a Windows™ socket API, as well as allowing multimedia access control such as the security feature of the DDA terminal 102. The API 210 also receives the USB data stream from the drivers 212.

The decoded broadcast channel content is provided to the computer 106 via the drivers 212 and I/O interfaces 214. The drivers 212 also allow the computer 106 to control the operation of the DDA terminal 102 through the USB interface. Drivers 212 supports plug and play features and also the Network Driver Interface Specification 4.0 (NDIS 4.0) which is herein incorporated by reference.

The I/O interfaces also support the USB interface standard which is herein incorporated by reference. The connector cable 222 is preferably a USB cable having a USB series A plug connector for connecting to computer 106 and a USB series B plug for connecting to the DDA terminal 102. Both ends of connector cable 222 are detachable and connector cable 222 is preferably 32 meters in length.

As previously discussed above, the computer 106 powers the DDA terminal 102. However, the maximum current drawn by the DDA terminal 102 is preferably limited to 100 ma as provided in the USB specification document. The USB GND signal serves as a common reference voltage between the DDA terminal 102 and computer 106.

In addition, the USB protocol allows for the DDA terminal 102 to report status information. The status information includes, but is not limited, to diagnostic results and incoming broadcast channel status information. Furthermore, the USB protocol allows isochronous transfer for data transmission to computer 106.

Status indicator 216 is preferably two light emitting diodes (LEDs). One of the LEDs is red which indicates an error condition. The other LED is green and has two states solid and flashing. Flashing indicates the DDA terminal 102 is operating correctly and transferring information to the computer 106. Solid indicates that the DDA terminal 102 is operating correctly, but no information is being transferred to the computer 106.

The USB port 108 interfaces with I/O interfaces 214 and allows users to communicate with the DDA terminal 102 via the API 210 and off-line card control software 208 or via other application software. The off-line card control 208 software is the GUI software used to communicate with the DDA terminal 102. Specifically, the off-line card control software 208 allows the optioning and configuration of the DDA terminal 102. API 210 serves as an interface between the off-line card control software 208 and drivers 212.

The DDA terminal 102 is fully compatible with various operating systems such as Windows™ and the like. Thus, an application can utilize the Windows™ operating system for multimedia. For example, the broadcast system can contain video content, and the Windows™ operating system can be used to view the content without the use of the API 210 and/or off-line control software 208.

It will be appreciated by those skilled in the art that, although the off-line control software 208 and the API 210 are depicted as separate entities, the two can be combined to form one entity while performing the functions of both entities.

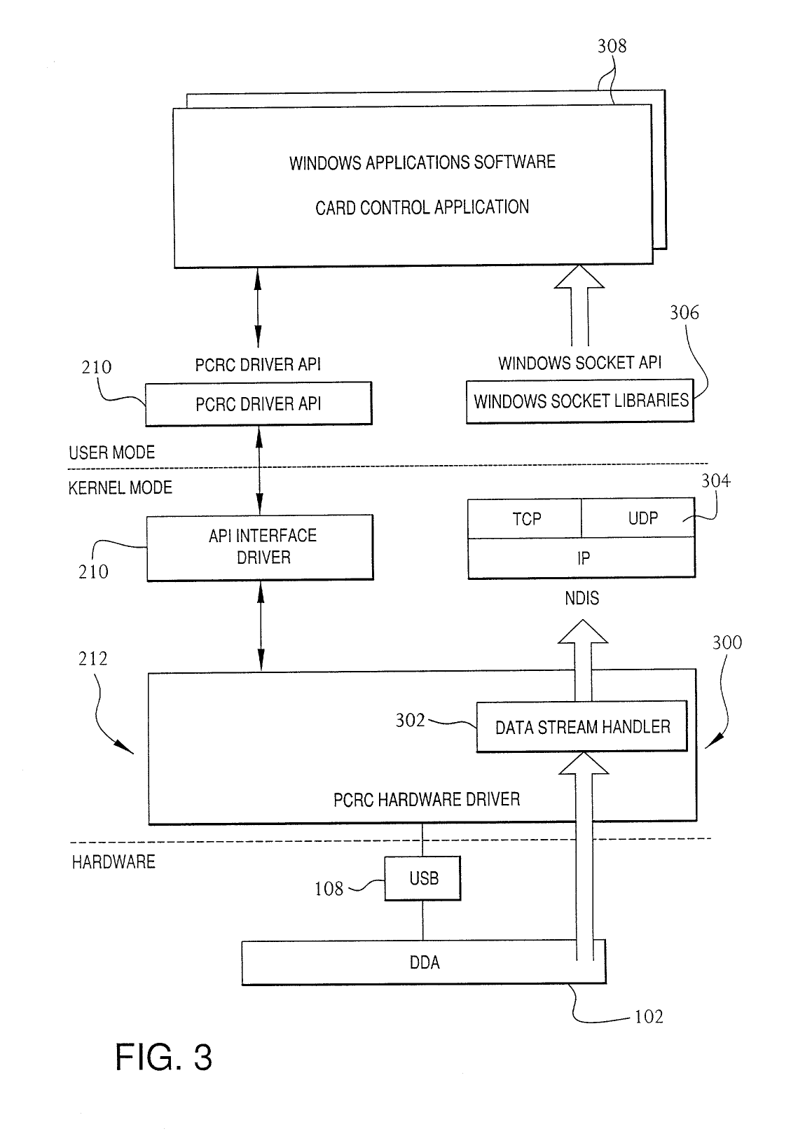

FIG. 3 is a block diagram depicting a driver software architecture 300 for the DDA terminal 102 of FIG. 2. The drivers 212 preferably control the DDA terminal 102 and all of its hardware components by accessing the terminal's hardware registers. The drivers 212 are responsible for plug-and-play functions and ensure the proper configuration of the hardware resources (I/O ports, IRQ line) required by the DDA terminal 102. At startup, the drivers 212 perform necessary initialization steps and place the DDA terminal 102 into an operational state.

The drivers 212 support the off-line card control software 208 that is accessed by the API 210. At this software interface, the drivers 212 support control requests that enable access to the features of the DDA terminal 102. In addition, there are requests that control operation of the drivers 212, such as its handling of the data stream.

The drivers 212 interface with the Windows™ network protocol stack that is provided by Microsoft as part of its operating system. The drivers 212 can provide an NDIS interface to a plurality of DDA terminals 102. Each of the terminals is operated separately and independently of one another.

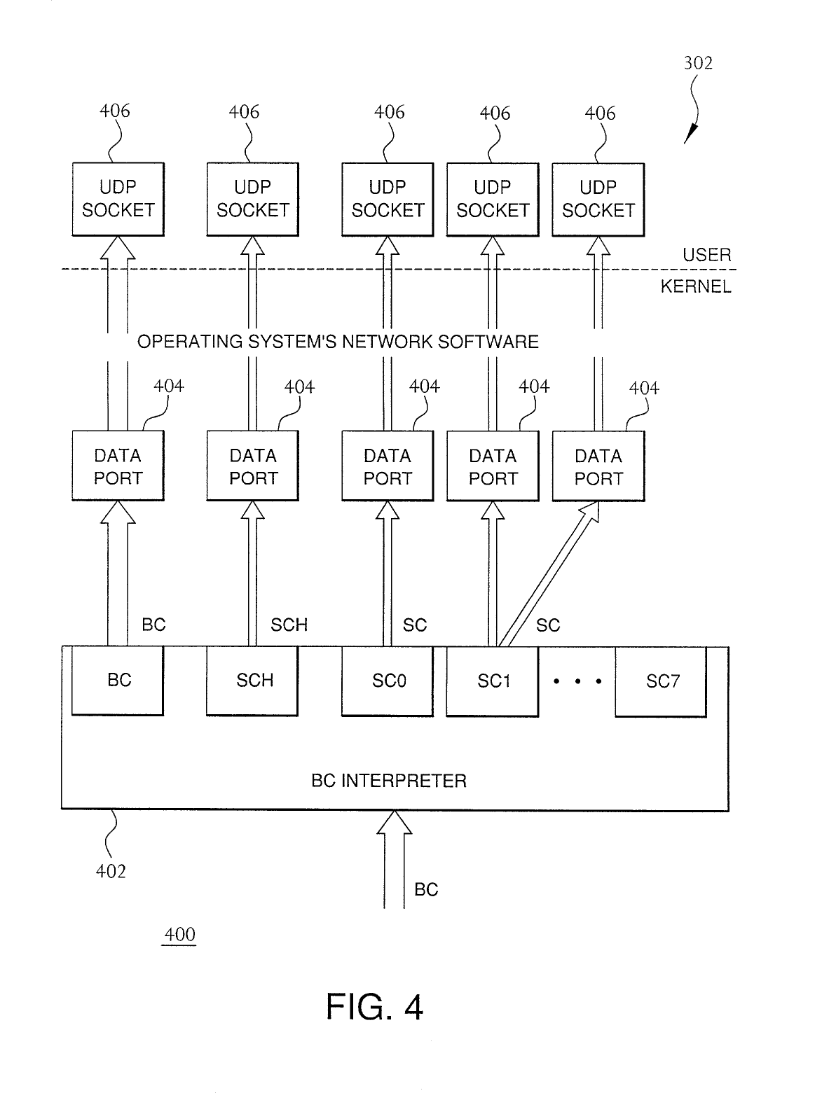

The drivers 212 also serve to provide data packets from the hardware of the DDA terminal 102 to the Windows™ Internet Protocol (IP) protocol stack 304. Specifically, within drivers 212 is a data stream handler 302 for handling the digital data streams received from the USB port 108. The data stream handler 302 formats the data stream from the USB port 108 into suitable IP packets comprising, for instance, User Datagram Protocol (UDP) and Real-time Transport Protocol (RTP) packets and the like. The IP packets are preferably provided to the Windows™ IP protocol stack via NDIS functions. The operation of the data stream handler 302 will be discussed with reference to FIG. 4 below.

The windows socket libraries 306 provide communication between the IP protocol stack 304 and window applications 308. Windows applications 308 provide, but is not limited, to satellite broadcast processing software and card control application software.

The API 210 provides access to the programming interface to the drivers 212 from a user level mode. This is necessary to implement the API 210 in the form of a Dynamic Link Library (DLL). In addition, the API 210 provides a method of routing requests from a user level to a kernel level. The DLL provides a C programming interface to control the DDA terminal 102. API 210 can be used by any Win32 application 308, including card control software 208.

FIG. 4 is a block diagram depicting the operation of the data stream handler 302 of FIG. 3 according to the present invention. The software drivers can be updated over the air via information contained in the broadcast channel. Therefore, rather than requiring a user to load software to update the DDA terminal 102, the updating of software drivers can be accomplished without the user's awareness of it. The data stream handler 302 is responsible for handling the digital data streams received by the USB port 108. Each receiver on the card produces a Broadcast Channel (BC) data stream. Initially, the data stream handler 302 performs any processing that is necessary to reclaim the BC data streams from the hardware (frame synchronization for example) of the DDA terminal 102. Once that initial step is completed, one BC data stream is available for further processing.

The BC data stream is processed by a software module called a BC Interpreter 402. There is preferably one instance of the BC Interpreter per channel of the dual channel digital satellite card 14. Therefore, the BC Interpreter works independently for each broadcast channel.

As FIG. 4 illustrates several possibilities for connecting outputs of the BC Interpreter 402 to a plurality of data ports 404. In one embodiment, a BC Interpreter 402 output can be left unconnected, as shown for Service Component (SC) 7 in FIG. 4. The output data stream, however, will be discarded. In another embodiment, the BC Interpreter 402 output is connected to one of the plurality of data ports 404, as shown for BC and SC 0. The output data stream is forwarded to the one of the plurality of UDP sockets 406 associated with the respective one of the plurality of data ports 404. In still another embodiment, the BC Interpreter 402 output is connected to more than one of the plurality of data ports 404, as shown for SC 1. The output data stream is preferably forwarded to all of the plurality of UDP sockets 406 in parallel.

Each of the BC Interpreter 402 outputs can be connected to one of the plurality of data ports 404. A data port represents an association with a UDP socket. The UDP socket 406 is used by the application to receive the data stream. Data ports 404 are created and deleted by the application using appropriate driver API functions. The application performs several steps to gain access to an output data stream of the BC Interpreter 402. First, the UDP socket is first created. This is done by using the system function socket command. The result is a socket descriptor. Next, a UDP port number is allocated. This is done by using the system function bind command. The result is a port number allocated by the system. Finally, a data port is created. This is done by using the driver API function “WsCreateDataPort” command. This function allows the user to specify which BC Interpreter 402 output the data port or the socket, respectively, can be connected to.

After these steps are successfully completed, the application is able to receive the data stream at the socket. The system function “recvfrom” command is used for this purpose. The application should delete the Data Port by using the “WsDeleteDataPort” command before it destroys the associated socket. This is important because the UDP port number may be reused by another application after it is cleared.

The device driver does not receive any notification from the operating system if a socket is created or deleted. For that reason, the application is preferably responsible for proper creation and deletion of data ports to ensure consistency of sockets and data ports.

As discussed above, the BC Interpreter 402 is responsible for formatting the data stream into UDP/IP packets. This is done based on the type of data stream or the output of the BC Interpreter. By default, the driver uses the following values for building the IP header:

Source IP Address: 0.0.0.0 (means this host on this network),

Destination IP Address: 255.255.255.255 (local broadcast address).

By default, the driver uses the following values for building the UDP header:

Source Port: 0 (means not available)

Destination Port: Port Number from connected data port as provided by the application.

Using these values ensures that the application is able to receive the data packets at the Socket Interface. In order to avoid possible conflicts with network adapters installed on the system, no IP addresses are used in the headers. The local broadcast address (255.255.255.255) is used instead. The UDP port number is sufficient to identify the socket unambiguously. As a consequence of this approach it is not necessary to assign a valid IP address to the receiver card. Again, this avoids conflicts with network cards.

There is preferably only one BC output provided at each BC interpreter 402. A UDP packet generated at the BC output of the BC interpreter contains a complete BC frame, starting with the Service Control Header and followed by the service data. The application receives complete BC frames at the socket. Therefore, the BC frames are packet aligned. The packet length is a multiple of 892 bytes: Packet Length=n*892, n=1 . . . 8. The frame period is 432 ms.

There is preferably only one SCH output provided at each BC interpreter 402. A UDP packet generated at the SCH output of the BC interpreter contains a complete Service Control Header (SCH). The Service Control Header is extracted from the BC frame by the device driver. The application receives Service Control Headers at the socket. The packet length is a multiple of 28 bytes: Packet Length=n*28, n=1 . . . 8. The packet period is 432 ms.

There are 8 SC outputs provided at each BC interpreter 402, one for each Service Component (SC). A UDP packet generated at an SC output of the BC interpreter contains all the data bytes of one SC from one BC frame. The raw data of the corresponding Service Component is extracted from the BC frame by the device driver. The packet length depends on the bit rate of the Service Component and is a multiple of 432 bytes: Packet Length=n*432, n=1 . . . 16. The packet period is 432 ms.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and the following claims.

1. A system for providing portable satellite access comprising:
a receiver for receiving broadcast content transmitted from a satellite;
a computer for processing at least part of said broadcast content received via said receiver; and
a terminal connecting said receiver and said computer, said terminal being operable to convert said broadcast content received from said receiver from a first signal format including a Broadcast Channel Input Output (BCIO) signal to a second signal format, wherein said second signal formatted signal is compatible with said computer.

2. A system as claimed in claim 1, wherein said second signal format comprises a Universal Serial Bus (USB) format signal.

3. A system as claimed in claim 1, wherein said first signal format comprises audio, video and data.

4. A system as claimed in claim 1, wherein said second signal format comprises video and data.

5. A system as claimed in claim 1, wherein said terminal is portable.

6. A system as claimed in claim 1, wherein said terminal is powered via said computer.

7. A system as claimed in claim 1, wherein said receiver comprises a satellite direct radio broadcast receiver.

8. A system as claimed in claim 1, wherein said receiver is operable to select channels from said broadcast content.

9. A system as claimed in claim 1, wherein said terminal is operable to provide status information for indicating whether content is being provided to said computer.

10. A system as claimed in claim 1, wherein said receiver provides a first level of security and said terminal provides a second level of security.

11. A system as claimed in claim 10, wherein said first level of security comprises entering a password to access said broadcast content.

12. A system as claimed in claim 10, wherein said second level of security comprises the terminal detecting its serial number within header information in said broadcast content.

13. A terminal for providing portable satellite access to a computer comprising:
a memory device; and
a processor connected to said memory device and operable in accordance with computer code to receive a satellite broadcast signal from a receiver in a Broadcast Channel Input Output (BCIO) signal format and provide said satellite broadcast signal to said computer in a second signal format.

14. The terminal of claim 13, wherein said processor is connected to a decoder for decoding said broadcast signal.

15. The terminal of claim 13, wherein said processor is connected to drivers for performing frame and byte synchronization of the satellite broadcast signal.

16. The terminal of claim 13, wherein said second signal format comprises a Universal Serial Bus (USB) format signal.

17. The terminal of claim 13, wherein said satellite broadcast signal comprises a satellite direct radio broadcast signal.

18. The terminal of claim 13, wherein said first signal comprises audio, video and data.

19. The terminal of claim 13, wherein said second signal comprises video and data.

20. The terminal of claim 13, wherein at least two levels of security is provided.

21. The terminal of claim 20, wherein said receiver provides a first level of security and said terminal provides a second level of security.

22. The terminal of claim 21, wherein said first level of security comprises entering a password to access broadcast content.

23. The terminal of claim 21, wherein said second level of security comprises said terminal detecting its serial number within header information in broadcast content of said first signal.
